(19) United States
(12) Patent Application Publication
(10) Pub. No.: US 2022/0221998 A1
(43) Pub. Date: Jul. 14, 2022

(54) MEMORY MANAGEMENT METHOD, ELECTRONIC DEVICE AND NON-TRANSITORY COMPUTER-READABLE MEDIUM

(71) Applicants: SHENZHEN HEYTAP TECHNOLOGY CORP., LTD., Shenzhen (CN); GUANGDONG OPPO MOBILE TELECOMMUNICATIONS CORP., LTD., Dongguan (CN)

(72) Inventor: Ming XU, Dongguan (CN)

(21) Appl. No.: 17/706,485

(22) Filed: Mar. 28, 2022

Related U.S. Application Data
(63) Continuation of application No. PCT/CN2019/111763, filed on Oct. 17, 2019.

(51) Int. Cl. G06F 3/06

(52) U.S. Cl. CPC G06F 3/0631; G06F 3/0673; G06F 3/0604; G06F 3/0659

(57) ABSTRACT

A memory management method, an electronic device and a non-transitory computer-readable medium are disclosed. In the method, a memory allocation request sent by an application is acquired, the memory allocation request including a target memory value required by the application. An estimated remaining memory value is obtained according to the target memory value and a remaining memory value of an electronic device. It is determined whether the estimated remaining memory value is greater than a specified value, the specified value being greater than a minimum system memory threshold, and the minimum system memory threshold being the minimum memory value required for system operation of the electronic device. When it is determined that the estimated remaining memory value is smaller than the specified value, a memory recovery operation is performed, and a memory space corresponding to the target memory value is allocated to the application.

### CROSS-REFERENCE TO RELATED APPLICATION(S)

This application is a continuation of International Application PCT/CN2019/111763, filed Oct. 17, 2019, the entire disclosure of which is incorporated herein by reference.

### TECHNICAL FIELD

This disclosure relates to the technical field of mobile terminals, and particularly to a memory management method, an electronic device, and a non-transitory computer-readable medium.

### BACKGROUND

Mobile terminals, such as mobile phones and tablet computers, have become one of the most commonly used consumer electronics in people's daily lives. In the mobile terminals, the memory thereof is generally composed of Dynamic Random Access Memory (DRAM). DRAM has a limited capacity due to its low integration. As the user's requirements increase, more and more applications are installed in the mobile terminals, and the utilization of the memory space of the mobile terminal has become a hot topic of research.

### SUMMARY

In view of above, embodiments of the disclosure proposes a memory management method, an electronic device, and a non-transitory computer-readable medium.

In an aspect, the embodiments of the present disclosure provide a memory management method, which is performed by an electronic device. In the method, a memory allocation request sent from an application installed in the electronic device is acquired, where the memory allocation request includes a target memory value required by the application. An estimated remaining memory value is obtained according to the target memory value and a remaining memory value of the electronic device. It is determined whether the estimated remaining memory value is greater than a specified value, where the specified value is greater than a minimum system memory threshold, and the minimum system memory threshold is a minimum memory value required for system operation of the electronic device. When it is determined that the estimated remaining memory value is less than the specified value, a memory recovering operation is performed, and then a memory space corresponding to the target memory value is allocated to the application.

In another aspect, the embodiments of the present disclosure also provide an electronic device. The electronic device includes one or more processors; a memory storage, and one or more programs. The one or more programs are stored in the memory storage, and are configured to be executed by the one or more processors to implement the above-mentioned method.

In further another aspect, the embodiments of the present disclosure also provide a non-transitory computer-readable medium storing program codes executable by a processor. When multiple instructions in the program codes are executed by the processor, the processor is caused to implement the above-mentioned method.

### BRIEF DESCRIPTION OF THE DRAWINGS

In order to more clearly describe technical solutions of the embodiments of the disclosure, drawings needed to be used in the description of the embodiments will be briefly introduced hereafter. Obviously, the drawings in the following illustrate only some embodiments of the disclosure, and those skilled in the art can obtain other drawings based on these drawings without any creative work.

FIG. 1 illustrates a flowchart of a memory management method provided by an embodiment of the present disclosure;

FIG. 2 illustrates a flowchart of the memory management method provided by another embodiment of the present disclosure;

FIG. 3 illustrates a flowchart of the memory management method provided by yet another embodiment of the present disclosure;

FIG. 4 illustrates a flowchart of the memory management method provided by still another embodiment of the present disclosure;

FIG. 5 illustrates a flowchart of the memory management method provided by still yet another embodiment of the present disclosure;

FIG. 6 illustrates a flowchart of S550 of FIG. 5;

FIG. 7 illustrates a module block diagram of a memory management apparatus provided by an embodiment of the present disclosure;

FIG. 8 illustrates a module block diagram of the memory management apparatus provided by another embodiment of the present disclosure;

FIG. 9 illustrates a module block diagram of the memory management apparatus provided by yet another embodiment of the present disclosure;

FIG. 10 illustrates a structural block diagram of an electronic device provided by an embodiment of the present disclosure; and

FIG. 11 illustrates a storage unit configured to store or carry program codes for implementing the memory management method according to the embodiments of the present disclosure.

### DETAILED DESCRIPTION OF PREFERRED EMBODIMENTS

In order to enable those skilled in the art to better understand the solutions of the present disclosure, the technical solutions in the embodiments of the present disclosure will be described clearly and comprehensively in conjunction with the drawings in the embodiments of the present disclosure.

In the mobile terminals, memory is one of the important components, and it is a bridge for communication with the CPU. The running of all programs in the mobile terminal happens in the memory, thus the performance of the memory has a great impact on the mobile terminal. The memory is generally composed of Dynamic Random Access Memory (DRAM). DRAM has a limited capacity due to its low integration.

With the development of science and technology and the increase of people's demands, more and more applications (APPs) are installed on the mobile terminals. However, the caching of various applications and the background running of useless processes would cause the available memory space of the mobile terminal to become less and less, causing a problem of insufficient memory.

Taking the Android system as an example, the process and memory management mechanism of the Android system is different from the memory management mechanism of the traditional Windows system and other operating systems. In the Android system, after an application is switched to the background, it is still alive, and its occupied memory space is not completely released. As a result, when the user hangs more and more applications in the background, or when the remaining available memory in the system is limited, the system would respond slowly or the interface would freeze due to slow memory allocation.

The inventor found in the research that the memory management mechanism of the Android system is based on the Linux system, and the memory recovery is triggered only when the free memory space is lower than a watermark/level set by the system. In this case, if an application requests a large memory space and the current free memory space of the system cannot meet this request, the memory recovery is triggered. The system needs to release a used cache first, and frees up a part of the memory space corresponding to this cache for being allocated to a new process, which causes the memory allocation to take a long time. If such situation occurs frequently, it will cause the system to slow down and jam, and the user cannot perform the operation smoothly. For the traditional devices adopting the Linux system, this situation does not significant. However, as the resolution of the current smart devices becomes higher and higher and the system becomes more and more complex, the system is prone to responding slowly and jamming due to slow memory allocation when the system has a heavy load.

Therefore, in order to overcome the above defects, a memory management method is provided by the embodiments of the present disclosure, as shown in FIG. 1. The method is performed by an electronic device, and is directed at avoiding the jamming of the system that is caused due to insufficient remaining memory of the system when allocating a memory space to an application. Specifically, the method includes operations S101 to S104.

At block S101, a memory allocation request sent from an application is acquired, where the memory allocation request includes a target memory value required by the application.

There are multiple applications installed in the electronic device. When an application is started up, it sends a memory allocation request to the operating system of the electronic device, and the memory allocation request includes the target memory value required by the application. After acquiring the memory allocation request, the operating system parses the memory allocation request to obtain the target memory value required by the application, and subsequently allocates, according to the target memory value, a memory space corresponding to the target memory value to the application.

At block S102, an estimated remaining memory value is obtained according to the target memory value and a remaining memory value of the electronic device.

Specifically, the operating system of the electronic device acquires the remaining memory value of the electronic device. The remaining memory value refers to the size of the currently available free memory space of the electronic device. After the remaining memory value is acquired, the estimated remaining memory value may be obtained according to the target memory value and the remaining memory value of the electronic device. Specifically, a difference between the remaining memory value and the target memory value may be obtained as the estimated remaining memory value. For example, if the current remaining memory value of the electronic device is A, and the target memory value required by the application sending the memory allocation request is B, the estimated remaining memory value is A-B. Specifically, the estimated remaining memory value may be understood as follows: in the case where the size of the remaining memory space of the electronic device represents the remaining memory value, assuming that an operation of allocating the target memory value to the application is performed, the size of the remaining memory space of the electronic device, obtained after the target memory value is successfully allocated to the application, will become the estimated remaining memory value.

It should be noted that the above way of using the difference between the remaining memory value and the target memory value as the estimated remaining memory value is established for a case where the target memory value requested by the application is exactly the memory value required by the application and included in the memory allocation request sent by the application. In consideration of a case where the application may not run smoothly if the application is allocated with just the target memory value, the specific implementation of allocating the target memory value to the application is as follows: the target memory value required by the application is acquired from the memory allocation request, the obtained target memory value is increased by a constant value, and the increased target memory value is used as the new target memory value, that is, the target memory value is modified into B+C, i.e., an operation of B=B+C is executed. Specifically, it is still assumed that the current remaining memory value of the electronic device is A, the target memory value required by the application that sends the memory allocation request is B, and the estimated remaining memory value is A-B-C. The setting of C enables the memory space allocated to the application to be increased, but it will cause the estimated remaining memory value to be reduced.

At block S103, it is determined whether the estimated remaining memory value is less than a specified value, where the specified value is greater than a minimum system memory threshold.

The minimum system memory threshold is the minimum memory value required for the system operation of the electronic device. Specifically, the minimum system memory threshold may also be referred to as the system memory watermark. To ensure the normal operation of the system, the memory space of the electronic device needs to be greater than the system memory watermark, otherwise the operating system of the electronic device will not run normally due to insufficient memory.

With regard to the specified value being greater than the minimum system memory threshold, as an implementation, the specified value may be obtained by adding a positive number to the minimum system memory threshold, so that the specified value is greater than the minimum system memory threshold. It will be introduced in the subsequent embodiments, and will not be detailed here.

At block S104, in response to determining that the estimated remaining memory value is less than the specified value, a memory recovering operation is performed and then a memory space corresponding to the target memory value is allocated to the application.

It is determined whether the estimated remaining memory value is less than the specified value, and when it is determined that the estimated remaining memory value is less than the specified value, the memory recovering operation is performed. The memory recovering operation is configured to free up a part of the memory space of the electronic device, so that the remaining memory value can be increased after the electronic device executes the memory recovering operation, and accordingly, the remaining memory value of the electronic device can support the minimum memory required for the operation of the operating system after the memory space corresponding to the target memory value is allocated to the application.

Since the specified value is greater than the minimum memory value required for the system operation of the electronic device, and since the memory recovering operation is performed upon determining that the estimated remaining memory value is less than the specified value, compared with the case where the memory recovering operation is performed only when the remaining memory value is less than the minimum system memory threshold, the memory can be recovered in advance in the embodiments. That is, the memory recovering operation can be performed at an earlier time when the remaining memory is still relatively large. As such, it can avoid the memory allocation from being performed at a slow speed that would be caused due to the trigger of the system's memory recovering mechanism. In other words, it can avoid the memory recovering operation from being performed just when the remaining memory value is less than the minimum system memory threshold, and thus avoid a situation that it takes a long time to perform the memory recovering operation due to a too small remaining memory, for example, in which situation, more memory spaces need to be released and a long time is consumed, i.e., the memory recovering operation is performed at a slow speed, which causes a too long time to be taken for allocating a memory space to the application. Therefore, the embodiments of the present disclosure can improve the performance of the system and avoid the slow response and jamming of the system that occur when the load is heavy. In particular, when allocating a memory space for the application, the remaining memory value of the system, obtained after the allocation of the required memory value for the application, can be prevented from being less than the minimum system memory threshold, and thus the gamming of the system can be avoided.

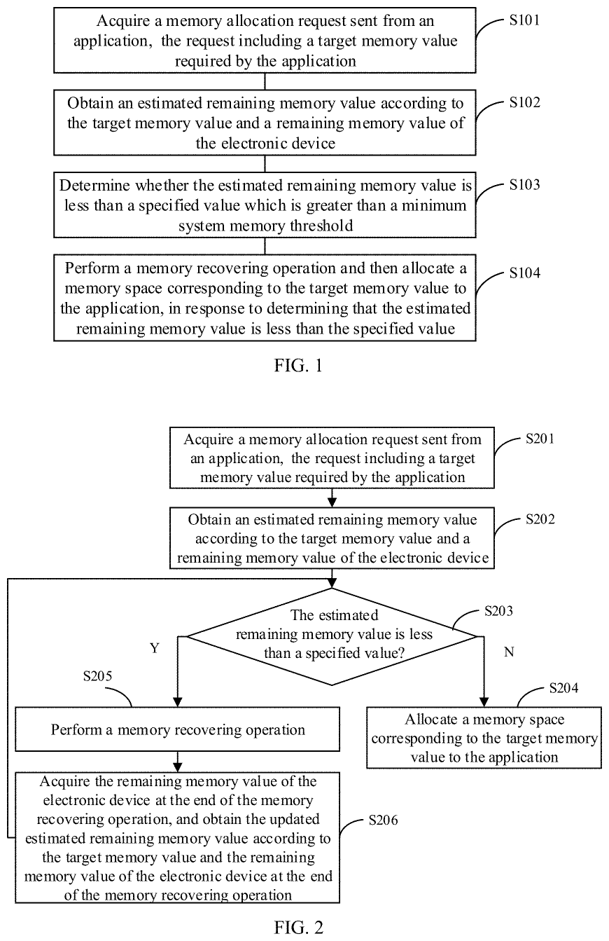

As shown in FIG. 2, a memory management method is provided by the embodiments of the present disclosure. The method is performed by an electronic device, and is directed at avoiding the jamming of the system that is caused due to insufficient remaining memory of the system when allocating a memory space to an application. Specifically, the method includes operations S201 to S206.

At block S201, a memory allocation request sent from an application is acquired, where the memory allocation request includes a target memory value required by the application.

At block S202, an estimated remaining memory value is obtained according to the target memory value and a remaining memory value of the electronic device.

At block S203, it is determined whether the estimated remaining memory value is less than a specified value.

The specified value is greater than a minimum system memory threshold, and the minimum system memory threshold is the minimum memory value required for the system operation of the electronic device.

The specified value is the sum of a buffer value and the minimum system memory threshold. The buffer value can be the above-mentioned positive number.

As another implementation, the buffer value is set according to a frame buffer. The frame buffer is a memory space occupied by Framebuffer. The Framebuffer can be regarded as a space for storing to-be-displayed data. The CPU or GPU puts the to-be-displayed data into the Framebuffer. A video controller reads the data from the Framebuffer according to a screen refresh rate and displays it on the screen.

As the resolution of electronic devices is getting higher and higher and the system is becoming more and more complex, the system's memory would be excessively occupied by the screen of the electronic device or the process of displaying contents on the screen under the user's control. Therefore, setting the specified value according to the size of the frame buffer enables the threshold for starting the memory recovering operation to take into account the screen resolution, which is more reasonable.

Specifically, the buffer value is a multiple of a preset memory value, where the preset memory value is the size of the memory space occupied by the frame buffer, that is, the preset memory value is the size of a memory space occupied by Framebuffer, and the buffer value is equal to the sum of the sizes of the memory spaces occupied by a preset number of the frame buffers. Since the resolution of the contents displayed on the screen of the electronic device is relatively high, and the contents are often displayed in real time when the screen of the electronic device is turned on, the Framebuffer will be frequently used. By using the sum of the buffer value being a multiple of the preset memory value and the system memory minimum threshold as the specified value, the memory usage of a preset number of frame buffers can be reserved in the system's memory allocation, thus making the setting of the specified value more reasonable. As an implementation, the buffer value is triple of the preset memory value, that is, the preset number is 3.

At block S204, a memory space corresponding to the target memory value is allocated to the application sending the memory allocation request.

Specifically, it is assumed that the estimated size of the remaining memory space of the electronic device, that is obtained after the electronic device allocates to the application the target memory value required by the application in response to the memory allocation request sent from the application, is the estimated remaining memory value. If the estimated remaining memory value is greater than or equal to the specified value, it indicates that the currently available memory space is sufficient, and then S204 is executed, in which the memory space corresponding to the target memory value is allocated for the application. At this time, since the available memory space is sufficient, it can prevent a long time from being taken to perform the memory allocation and thus prevent the application from being stuck, when allocating memory to the application.

At block S205, a memory recovering operation is performed.

If the estimated remaining memory value is less than the specified value, it indicates that the currently available memory space is insufficient, and the memory recovering operation needs to be performed. The memory recovering operation can be configured to free up the memory space occupied by applications currently running in the background of the electronic device. Specifically, at least one of the applications currently running in the background can be closed. The specific strategy for closing the application currently running in the background may be introduced in subsequent embodiments.

At block S206, the remaining memory value of the electronic device at the end of the memory recovering operation is acquired, and the estimated remaining memory value is obtained, according to the target memory value and the remaining memory value of the electronic device at the end of the memory recovering operation, as an updated estimated remaining memory value.

After the memory recovering operation is performed, the remaining memory value corresponding to the currently available remaining memory space of the electronic device can be obtained once again, that is, the remaining memory value of the electronic device at the end of the memory recovering operation is acquired. The estimated remaining memory value is obtained once again according to the target memory value and the remaining memory value of the electronic device at the end of the memory recovering operation, as the updated estimated remaining memory value. Then, it returns to operation S203. That is, after the updated estimated remaining memory value is obtained, it is determined once more whether the updated estimated remaining memory value is less than the specified value. If the updated estimated remaining memory value is still less than the specified value, the memory recovering operation is performed once again, and so on, until the estimated remaining memory value of the electronic device after the memory recovering operation is greater than or equal to the specified value, and at that time, the memory space corresponding to the target memory value is allocated to the application.

For example, when the electronic device receives the memory allocation request sent from an application, the remaining memory value of the electronic device is 100M, the specified value is 80M, and the target memory value required by the application is 40M. At this time, the estimated remaining memory value is 60M, the electronic device then determines that the estimated remaining memory value is less than the specified value, and performs the memory recovering operation with a memory space of 5M released. Then, the current remaining memory value of the electronic device is 105M, and the updated estimated remaining memory value is 65M; at this time, it is also determined that 65M is less than 80M, and the memory recovering operation is performed once again with another 20M released. Then, the current remaining memory value of the electronic device is 125M, and the updated estimated remaining memory value is 85M; at this time, it is determined that 85M is greater than 80M, and the memory space corresponding to the target memory value is allocated to the application.

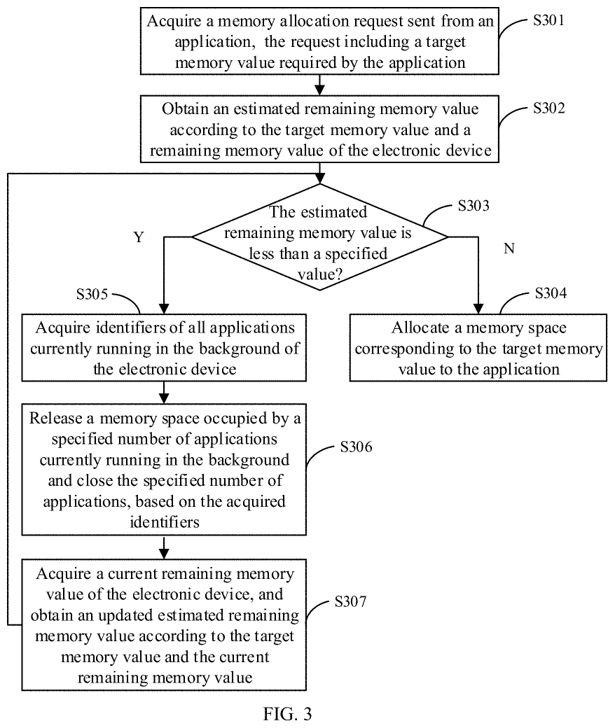

Specifically, regarding the memory recovering operation, reference may be made to FIG. 3 which shows the memory management method provided by the embodiments of the present disclosure. Specifically, the method includes operations S301 to S307.

At block S301, a memory allocation request sent from an application is acquired, where the memory allocation request includes a target memory value required by the application.

At block S302, an estimated remaining memory value is obtained according to the target memory value and a remaining memory value of the electronic device.

At block S303, it is determined whether the estimated remaining memory value is less than a specified value.

At block S304, a memory space corresponding to the target memory value is allocated to the application.

At block S305, identifiers of all applications currently running in the background of the electronic device are acquired.

States of an application includes a foreground running state, a background running state, and a non-running state. The foreground running state means that the application is running and presented on the screen in an interface, and the user can interact with the application through the interface, for example, the user can input an execution instruction or observe some information from the interface. The background running state means that the application is running in the resource manager of the system, and is not presented on the screen in an interface. When the user starts an application for the first time, the application runs and is rendered on the screen of the electronic device, that is, it is in the foreground running state. When the user clicks the home button, or switches another application to the foreground, or locks the screen of the electronic device, the state of the application is changed to the background running state. The non-running state means that the application is not started, that is, it is not running in the foreground or in the background. Specifically, the process of the application may be killed when the application is running in the foreground or background, and at this time, the application is in the non-running state, which is also called a closed state.

An application running state table is stored in the electronic device, and the table includes the identifiers of all applications currently installed on the electronic device and the states corresponding to the identifiers of the individual applications. For example, APP1 is the identifier of an application, which may be the name of the application, the package name, or other content used to indicate the identity of the application, and a corresponding point in time indicates the point in time when the application is switched to a corresponding state. For example, the point in time of APP1 is 13:20 on Nov. 3, 2017, which indicates the point in time when APP1 is running on the screen of the electronic device, that is, when it is switched to the foreground running state. By monitoring the application running state table, the state of each application currently installed on the electronic device can be monitored.

At block S306, based on the acquired identifiers, a memory space occupied by a specified number of applications currently running in the background is released, and the specified number of applications currently running in the background are closed.

In the embodiments of the present disclosure, the memory recovering operation is configured to determine the identifiers of the applications currently running in the background, and then based on the acquired identifiers, release the memory space occupied by a specified number of applications currently running in the background, and close the specified number of applications currently running in the background.

The recovering strategy may include: randomly selecting a specified number of identifiers from the identifiers the applications currently running in the background, as to-be-processed identifiers, freeing up the memory space occupied by the applications corresponding to the to-be-processed identifiers, and closing the applications corresponding to the to-be-processed identifiers. That is, the application corresponding to the to-be-processed identifier is neither running in the foreground nor in the background. Specifically, the processes of the applications corresponding to the to-be-processed identifiers are killed and the memory space occupied by these processes is released. As an implementation, the file page of the application that needs to be closed for the memory recovering may be moved to the disk, so that the memory space occupied by the application is freed up.

The operation S305 may be specifically implemented as follows: a current list of inactive file pages in the electronic device is acquired, where the list of inactive file pages includes a plurality of inactive file pages, and each inactive file page corresponds to the identifier of one application currently running in the background. The operation S306 may be specifically implemented as follows: the contents of the inactive file page corresponding to the identifier of an application currently running in the background are written to the disk, the inactive file page is deleted from the list of inactive file pages, and a memory page corresponding to the inactive file page is released.

The memory (also known as Random Access Memory, RAM) represents the memory used when running the applications (that is, running memory), which can only store data temporarily and exchange cache data with the processor, but the memory itself cannot be used as a long-term storage of data. When an application is running, it needs to take up a memory space to store the data produced in the running process thereof. The memory spaces occupied by different applications in different running states are not necessarily the same. The memory page is a unit for the operating system to manage the memory. The size of a unit memory space occupied by the memory page may not be limited, and the size of the unit memory space occupied by the memory page may be differently set by different mobile terminals.

The memory page can include an anonymous page, a file page and the like, which are not limited here. The anonymous page represents a page without a file context such as heaps, stacks, and data segments, which does not exist in the form of a file and cannot be exchanged with disk files. The file page represents a page with a file context, which is a cache generated in the memory after a file is read by an application, and is generally called a file cache. For example, when the memory recovering amount is set as 200, if the memory recovering parameter is 60, it means that the recovering ratio of the anonymous pages to the file pages is 60:140. Generally, the system kernel of the mobile terminal compresses some memory pages and stores them in the memory to save the memory space. Therefore, there are usually compressed memory pages in the memory. For example, the least recently used anonymous pages are compressed and stored in the memory.

The Android operating system adopts different recovering strategies for the anonymous pages from the file pages. The recovering strategy for the anonymous pages generally includes: compressing the anonymous pages and storing them in the random access memory (RAM). In this process, a central processing unit (CPU) is utilized to compress the anonymous pages and then decompress them when they need to be used. This recovering process requires a certain amount of CPU time, and is relatively slow. There are generally two recovering strategies for the file pages. If the file page has not been modified, the contents of the file page can be discarded directly; and if the contents of the file page have been modified, the contents of the file page need to be written back to the disk and then the file page is discarded, and the contents can be read from the disk when they need to be used.

In the above-mentioned operation of selecting a specified number of identifiers from the identifiers the applications currently running in the background as the to-be-processed identifiers, freeing up the memory space occupied by the applications corresponding to the to-be-processed identifiers, and closing the applications corresponding to the to-be-processed identifiers, the to-be-processed identifiers can be determined according to the type or the usage record of the application.

As an implementation, according to the usage records corresponding to the identifiers of the applications currently running in the background, a specified number of identifiers is selected from the identifiers of the applications currently running in the background as the to-be-processed identifiers, the memory space occupied by a specified number of applications currently running in the background corresponding to the to-be-processed identifiers is released, and the specified number of applications currently running in the background are closed.

Specifically, according to the usage records corresponding to the identifiers of the applications currently running in the background, a specified number of identifiers of the applications are selected, as first to-be-processed identifiers, from the identifiers of the applications currently running in the background. The usage record may include the usage frequency within a preset period of time. In this case, the usage frequency corresponding to the identifier of each of the applications currently running in the background is determined, and the identifiers of all the applications currently running in the background are arranged in an ascending order according to the usage frequencies thereof, to obtain a first usage sequence. In the first usage sequence, the lower the usage frequency of an application, the higher the identifier of the application is ranked.

The first N identifiers of the applications are selected from the usage sequence as the first to-be-processed identifiers, where N is a positive integer. Accordingly, when the memory recovering operation is performed, N applications that are less frequently used are closed, and their corresponding memory space is released. Specifically, the contents of the inactive file pages corresponding to the first to-be-processed identifiers are written to the disk, these inactive file pages are deleted from the list of inactive file pages, and the memory pages corresponding to these inactive file pages are released.

In addition, the usage record may also include the most recent usage time. In this case, the most recent usage time corresponding to the identifier of each of the applications currently running in the background may be determined, and the identifiers of all the applications currently running in the background are arranged in an order from early to late according to the most recent usage time, to obtain a second usage sequence. In the second usage sequence, the earlier the most recent usage time of an application, the higher the identifier of the application is ranked.

The first N identifiers of the applications are selected from the usage sequence as the first to-be-processed identifiers, where N is a positive integer. Accordingly, when the memory recovering operation is performed, N applications that were used earlier are closed, and their corresponding memory space is released.

In addition, the above-mentioned usage time and usage frequency may be used in combination. That is, according to the most recent usage time and the usage frequency corresponding to the identifier of each application currently running in the background, the to-be-processed identifiers are determined, the memory space occupied by a specified number of applications currently running in the background corresponding to the to-be-processed identifiers is released, and the specified number of applications currently running in the background are closed.

Specifically, in some embodiments, the top M identifiers of the applications are determined in the above-mentioned first usage sequence, and then the most recent usage time corresponding to each of the M identifiers of the applications is acquired. The M identifiers of the applications are arranged in an order from early to late according to the most recent usage time, to obtain the third usage sequence. In the third usage sequence, the earlier the most recent usage time of an application, the higher the identifier of the application is ranked. N identifiers of the applications are selected from the third usage sequence as the first to-be-processed identifiers, where M is a positive integer greater than N.

In other embodiments, the top M identifiers of the applications are determined in the second usage sequence, and then the usage frequency corresponding to each of the M identifiers of the applications is obtained. The M identifiers of the applications are arranged in an ascending order according to the usage frequencies, to obtain a fourth usage sequence. In the fourth usage sequence, the lower the usage frequency of an application, the higher the identifier of the application is ranked. N identifiers of the applications are selected from the fourth usage sequence as the first to-be-processed identifiers.

In addition, according to the types of applications corresponding to the identifiers of the applications currently running in the background, it is also possible to release the memory space occupied by a specified number of applications currently running in the background corresponding to the to-be-processed identifiers, and close the specified number of applications currently running in the background.

It should be noted that, in the embodiments of the present disclosure, the determined applications currently running in the background are applications installed in the electronic device. Specifically, the electronic device obtains the type of each installed application in advance. Specifically, it is shown in the following table:

TABLE 1

| Identifier of the application | Type of the application |
|---|---|
| UID1 | Game |
| UID2 | Video |
| UID3 | Audio |
| UID4 | Social |

The type of the application mentioned above may be a type set for the application by the developer of the application during development, or a type set by the user for the application after the application is installed on the electronic device. For example, the user may install an application on the electronic device, and after the installation is completed and the application is entered, a dialog box may be displayed to instruct the user to set a type for the application. The specific type of the application can be set by the user as required. For example, the user can set the type of some social software as audio, video, or social.

In addition, application installation software is installed in the electronic device, such as Appstore in the iOS system. In this case, there is an application list in the application installation software, in which list the users can download applications and update and open applications. And the application installation software can display different applications according to their types, such as audio, video or game. Therefore, when the user installs an application using the application installation software, he/she can know the type of the application.

In addition, there are some applications which can play not only video but also audio. If an application supports video playback, the type of the application is set as video. If the application does not support the video playback and supports only audio playback, the type of the application is set as audio. Specifically, whether the application supports the video playback can be determined by the function description contained in the function description information of the application. For example, it may be determined whether an application supports the video playback function, by detecting whether the playback of a video format is supported according to the supported playback formats, or by detecting whether the program module of the application includes a video playback module such as the codec algorithm for certain video playback.

Furthermore, if some applications have diversified functions, the types of such applications may be determined according to the specific operating behaviors thereof. For example, if an application can play not only video but also audio, for example some video playback software can play not only pure audio files but also videos, the type of such application can be determined according to the usage record thereof. That is, according to the usage record of the application within a certain period of time, it may be determined whether the user would like to use the application to play video or audio.

Specifically, the operation behavior data of the application related to all users in a preset period of time is acquired, where all users refer to all users who have installed the application. The operation behavior data can be acquired from the server corresponding to the application. That is, when the user uses the application, he/she will use the corresponding user account to log in to the application, the operation behavior data corresponding to the user account will be sent to the server corresponding to the application, and the server stores the obtained operation behavior data correspondingly to the user account. In some embodiments, the electronic device sends an operation behavior query request for an application to the server corresponding to the application, and the server sends the operation behavior data of all users within a preset period of time to the electronic device.

The operation behavior data includes the name and playing time of the played audio file, as well as the name and playing time of the played video file. By analyzing the operation behavior data, it is possible to determine the number of the audio files played by the application within a preset period of time and the corresponding total playing time, and determine the number of the video files played by the application within the preset period of time and the corresponding total playing time. Then, according to the proportions of the total playing time of the audio and video files to the preset period of time, the type of the application is determined. Specifically, the proportions of the total playing time of the audio and video files to the preset period of time are acquired. For the convenience of description, the proportion of the total playing time of the audio files to the preset period of time is indicated as the proportion of audio playback, and the proportion of the total playing time of the video files to the preset period of time is indicated as the proportion of video playback. If the proportion of video playback is greater than the proportion of audio playback, the type of application is set as video. If the proportion of audio playback is greater than the proportion of video playback, the type of the application is set as audio. For example, if the preset period of time is 30 days, that is 720 hours, and the total playing time of the audio files is 200 hours, the proportion of audio playback is 27.8%; and the total playing time of the video files is 330 hours, then the proportion of video playback is 45.8%. That is, the proportion of video playback is greater than the proportion of audio playback, and the type of the application is set as video.

As another implementation, the UID of the application in the electronic device is composed of a series of numbers, and there is a certain regularity in the arrangement of the numbers. For different types of applications, the number segments of corresponding UIDs are different. For example, applications with UIDs ranging from 00000 to 09999 belong to a same type, such as games. Therefore, the type corresponding to the application can be determined according to the UID of the application.

Regarding the operation of releasing the memory space occupied the specified number of applications currently running in the background corresponding to the to-be-processed identifiers and closing the specified number of applications currently running in the background, the specific implementation thereof may include determining the identifiers of all the applications currently running in the background as candidate identifiers, in which the “current” therein refers to a time moment when the operation S306 is executed.

The type of the application corresponding to each of the candidate identifiers is acquired, in which the way of determining the type can refer to the above description. Then, the identifiers corresponding to a specified type are determined from the candidate identifiers. The specified type can be video or game, that is because when the video and game applications are run in the background, the user cannot operate them, but the video and game applications rely on the user's operation. For example, when a video application is playing video, it is meaningless if the video is not watched by the user. For another example, if the game application is not operated by the user, it has no meaning to run.

Then, the to-be-processed identifiers are selected from the identifiers of the applications of the specified type currently running in the background, the memory space occupied by a specified number of applications currently running in the background corresponding to the to-be-processed identifiers is released, and the specified number of applications currently running in the background are closed. Specifically, a specified number of identifiers are determined from the identifiers of the applications of the specified type currently running in the background, as the to-be-processed identifiers. The memory space occupied by the applications corresponding to the to-be-processed identifiers is freed up, and the applications corresponding to the to-be-processed identifiers are closed. In addition, if no identifier corresponding to the specified type exists in the candidate identifiers, a specified number of identifiers can be directly determined from the candidate identifiers of the applications currently running in the background, as the to-be-processed identifiers, the memory space occupied by the applications corresponding to the to-be-processed identifiers is freed up, and the applications corresponding to the to-be-processed identifiers are closed. The implementations of determining the to-be-processed identifiers and recovering the memory space according to the to-be-processed identifiers can refer to the above description, which will not be repeated here.

In addition, some applications of the electronic device need to keep running, so that the electronic device can be used normally; alternatively, in order to satisfy the user experience provided by the electronic device, it is necessary to make some specific applications run in the background, where the identifiers of the specific applications can be set by the user as required, of course, the identifiers of the specific applications can also be the identifiers of system applications. In view of this, after the identifiers of the applications currently running in the background are determined, the identifiers of other applications than the specific applications are selected therefrom as the candidate identifiers. Then, a specified number of identifiers of the applications currently running in the background are selected from the candidate identifiers according to the types of the applications, the memory space occupied by the specified number of applications corresponding to the selected identifiers is released, and the specified number of applications currently running in the background are closed.

The type of the application can include a system application and a non-system application.

Specifically, the system application is an application that is installed in conjunction with the operating system of the electronic device, which is already installed in the electronic device when the electronic device leaves the factory, or the client of which is already stored in the electronic device when the electronic device leaves the factory, in which case, the user can be guided to install the client when the electronic device is turned on for the first time. The client of the system application is upgraded with the upgrade of the operating system of the electronic device, and it is in a strong coupling relationship with the operating system. The client of the system application cannot be upgraded automatically or does not have the ability to be upgraded automatically, such as the camera application, which relies heavily on the hardware and system of electronic device. The non-system application is a client that can be upgraded independently, instead of having to be upgraded with the update of the system.

After the identifiers of the applications currently running in the background are determined, the identifiers of other applications than the system applications are selected therefrom as the candidate identifiers, that is, the identifiers of the non-system applications currently running in the background are selected as the candidate identifiers.

At block S307, a current remaining memory value of the electronic device is acquired, and an updated estimated remaining memory value is obtained according to the target memory value and the current remaining memory value of the electronic device.

In the embodiments of the present disclosure, after operation S306 is executed, operation S304 may be directly executed, that is, the memory space corresponding to the target memory value is allocated to the requesting application. Since the available memory space of the electronic device is increased after operations S305 and S306, that is, a part of the memory space has been released, at this time, the estimated remaining memory obtained from the target memory value and the current remaining memory value may be already larger than the specified value. Of course, it is also possible to perform operation S307 after operation S306, that is, it is determined whether the updated estimated remaining memory value is less than the specified value, and it is determined, according to such determination result, whether to perform operation S304 or perform the memory recovering operation once again.

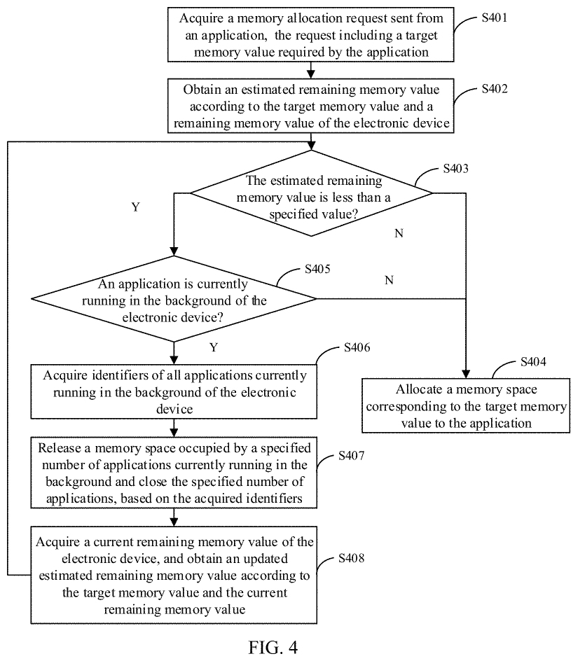

In addition, it is still possible to determine whether there are still some applications whose occupied memory space can be released when performing the recovering operation. If not, there is no need to perform the memory recovering operation. Specifically, referring to FIG. 4, the memory management method provided by the embodiments of the present disclosure is illustrated. Specifically, the method includes operations S401 to S408.

At block S401, a memory allocation request sent from an application is acquired, where the memory allocation request includes a target memory value required by the application.

At block S402, an estimated remaining memory value is obtained according to the target memory value and a remaining memory value of the electronic device.

At block S403, it is determined whether the estimated remaining memory value is less than a specified value.

At block S404, a memory space corresponding to the target memory value is allocated to the application.

At block S405, it is detected whether there is an application currently running in the background of the electronic device.

Specifically, when the electronic device performs the memory recovering operation, it releases the memory space of a specified number of applications each time, until it traverses the list of inactive file pages in the electronic device. That is, at each time, the specified number of file pages are selected from the list of inactive file pages, the contents of the selected file pages are moved to the disk, and the memory pages corresponding to the selected inactive file pages are freed up. In other words, each time the memory recovering operation is performed, the specified number of file pages are deleted from the list of inactive file pages. In theory, after traversing the list of inactive file pages, each inactive file page in the list of inactive file pages will be deleted.

The contents of the inactive file page may be the contents of the memory page corresponding to the inactive file page, that is, the information in the memory space occupied by the application of the inactive page, and the information may be descriptive information such as the address and size of the memory space.

At block S406, identifiers of all applications currently running in the background of the electronic device are acquired.

At block S407, based on the acquired identifiers, a memory space occupied by a specified number of applications currently running in the background is released, and the specified number of applications currently running in the background are closed.

At block S408, a current remaining memory value of the electronic device is acquired, and an updated estimated remaining memory value is obtained according to the target memory value and the current remaining memory value of the electronic device.

Specifically, when the specified number is 1, the specific implementation of operations S405 to S407 above may be as follows. If the estimated remaining memory value is less than the specified value, then the list of inactive file pages in the electronic device is traversed. That is, each time one inactive file page is selected from the list of inactive file pages, and the contents of the selected file page, that is, the contents of the corresponding memory page are written back to the disk, and the memory page is added to the free list, as such, the selected file page is deleted from the list of inactive file pages; then, the current remaining memory value of the electronic device is acquired once again, the updated estimated remaining memory value is obtained according to the target memory value and the current remaining memory value of the electronic device, and the method is returned to determine whether the estimated remaining memory value is less than the specified value. If the updated estimated remaining memory value is less than the specified value, it is determined whether the list of inactive file pages has been traversed, that is, it is detected whether there is still an application currently running in the background of the electronic device. If the list of inactive file pages has not been traversed, the operation of traversing the list of inactive file pages in the electronic device is continued, until it is determined that the estimated remaining memory value is greater than or equal to the specified value, or the traversal of the list of inactive file pages is completed, then the operation of traversing the list of inactive file pages in the electronic device is ended.

In the case that the detection result of detecting whether there is an application currently running in the background of the electronic device is that no application is running in the background of the electronic device, the memory space corresponding to the target memory value may be directly allocated to the requesting application.

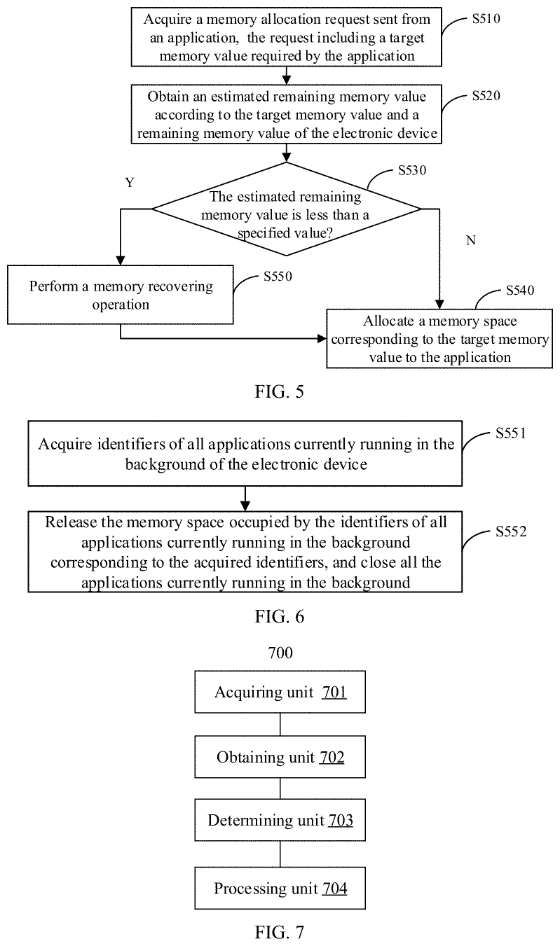

Referring to FIG. 5, the memory management method provided by the embodiments of the present disclosure is illustrated. Specifically, the method includes operations S510 to S550.

At block S510, a memory allocation request sent from an application is acquired, where the memory allocation request includes a target memory value required by the application.

At block S520, an estimated remaining memory value is obtained according to the target memory value and a remaining memory value of the electronic device.

At block S530, it is determined whether the estimated remaining memory value is less than a specified value.

At block S540, a memory space corresponding to the target memory value is allocated to the application.

For the specific implementations of operations S510 to S540, reference may be made to the foregoing embodiments, which will not be detailed herein again.

At block S550, a memory recovering operation is performed.

In this embodiment of the present disclosure, after the memory recovering operation is performed, the memory space corresponding to the target memory value is directly allocated for the application by default. That is because the remaining memory space of the electronic device is increased after the memory recovering operation is performed. If the memory space released during the memory recovering is large enough, the operation of allocating the memory space corresponding to the target memory value to the application can be directly performed, without returning to the operations of determining whether the estimated remaining memory value is less than the specified value and then determining, according to such determination result, whether to perform the memory recovering operation again or to allocate the memory space corresponding to the target memory value for the application.

Specifically, operation S550 includes S551 and S552.

At block S551, identifiers of all applications currently running in the background of the electronic device are acquired.

At block S552, the memory space occupied by all applications currently running in the background corresponding to the acquired identifiers is released, and all the applications currently running in the background are closed.

Specifically, regarding the operation of acquiring identifiers of all applications currently running in the background of the electronic device may include: acquiring the identifiers of applications meeting a selection condition, from the identifiers of all the applications currently running in the background of the electronic device, where the type corresponding to the identifier of the application meeting the selection condition is a preset type. The preset type can be the above-mentioned non-system application or the above-mentioned specified type, such as at least one of video and game.

Specifically, the identifiers of non-system applications are acquired from the identifiers of all applications currently running in the background of the electronic device, and the identifiers of all video and game applications are selected from the identifiers of the non-system applications as the to-be-processed identifiers. The memory space occupied by the applications corresponding to the to-be-processed identifiers is released, and all the applications currently running in the background corresponding to the to-be-processed identifiers are closed. Alternatively, the identifiers of all non-system applications currently running in the background of the electronic device may be determined as the to-be-processed identifiers.

The way of releasing the memory space may refer to the above-mentioned operations for the file pages in the list of inactive file pages and the corresponding memory pages, which will not be repeated here.

It should be noted that the foregoing memory recovering operation may be performed in a memory recovering thread.

Then, after operation S552 is executed, the memory space corresponding to the target memory value can be directly allocated to the application.

Specifically, the foregoing operation of performing the memory recovering operation may include: setting a memory recovering thread, and performing the memory recovering operation in the memory recovering thread. The operation of allocating the memory space for the application in response to the application's memory allocation request is performed in a memory allocation thread. That is, the memory recovering thread and the memory allocation thread are two different threads. As such, the memory recovering process will not block the memory allocation process.

The memory recovering thread may be a pre-kswapd thread. The pre-kswapd is a process of memory recovery for the user in the Android system, which belongs to the kernel thread. The kswapd is a kernel thread used for page recovery in Linux, and the kernel thread kswapd will scan regularly or be awakened when needed.

In addition, there is only one memory recovering thread in the operating system. In this case, the operation of setting a memory recovering thread and performing the memory recovering operation in the memory recovering thread includes: determining whether there is an existing memory recovering thread in the system; if there is an existing memory recovering thread in the system, performing the memory recovering operation in the existing memory recovering thread; and if there is no existing memory recovering thread in the system, creating a memory recovering thread, and performing the memory recovering operation in the created memory recovering thread.

If there is an existing pre-kswapd thread, no new pre-kswapd thread is created, and the existing pre-kswapd thread will be used directly to perform the memory recovering operation, avoiding too many threads from occupying too much memory.

Referring to FIG. 7, a structural block diagram of a memory management apparatus 700 provided by the embodiments of the present disclosure is illustrated. The apparatus 700 may include an acquiring unit 701, an obtaining unit 702, a determining unit 703, and a processing unit 704.

The acquiring unit 701 is configured to acquire a memory allocation request sent from an application, where the memory allocation request includes a target memory value required by the application.

The obtaining unit 702 is configured to obtain an estimated remaining memory value according to the target memory value and a remaining memory value of the electronic device.

Specifically, a difference between the remaining memory value and the target memory value is obtained as the estimated remaining memory value.

The determining unit 703 is configured to determine whether the estimated remaining memory value is less than a specified value, where the specified value is greater than a minimum system memory threshold, and the minimum system memory threshold is the minimum memory value required for the system operation of the electronic device.

Specifically, the specified value is the sum of a buffer value and the minimum system memory threshold. The buffer value is set according to a frame buffer. As an implementation, the buffer value is a multiple of a preset memory value, where the preset memory value is the size of a memory space occupied by the frame buffer. For example, the buffer value is triple of the preset memory value.

The processing unit 704 is configured to perform a memory recovering operation and then allocate a memory space corresponding to the target memory value to the application, when it is determined that the estimated remaining memory value is less than the specified value.

Those skilled in the art can clearly understand that, for the convenience and conciseness of the description, the specific working process of the apparatus and units described above can be referred to the corresponding process in the foregoing method embodiments, which will not be repeated here.

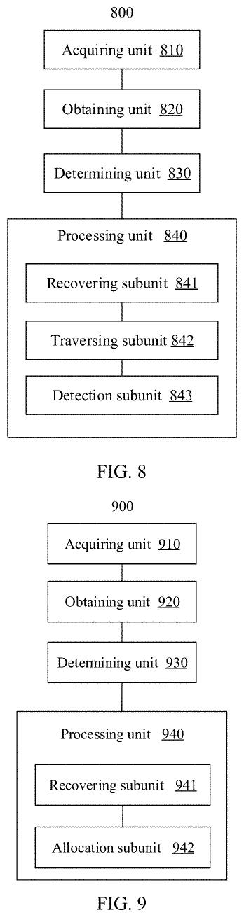

Referring to FIG. 8, a structural block diagram of the memory management apparatus 800 provided by the embodiments of the present disclosure is illustrated. The apparatus 800 may include an acquiring unit 810, an obtaining unit 820, a determining unit 830, and a processing unit 840.

The acquiring unit 810 is configured to acquire a memory allocation request sent from an application, where the memory allocation request includes a target memory value required by the application.

The obtaining unit 820 is configured to obtain an estimated remaining memory value according to the target memory value and a remaining memory value of the electronic device.

Specifically, a difference between the remaining memory value and the target memory value is obtained as the estimated remaining memory value.

The determining unit 830 is configured to determine whether the estimated remaining memory value is less than a specified value, where the specified value is greater than a minimum system memory threshold, and the minimum system memory threshold is the minimum memory value required for the system operation of the electronic device.

Specifically, the specified value is the sum of a buffer value and the minimum system memory threshold. The buffer value is set according to a frame buffer. As an implementation, the buffer value is a multiple of a preset memory value, where the preset memory value is the size of a memory space occupied by the frame buffer. For example, the buffer value is triple of the preset memory value.

The processing unit 840 is configured to perform a memory recovering operation and then allocate a memory space corresponding to the target memory value to the application, when it is determined that the estimated remaining memory value is less than the specified value.

Specifically, the processing unit 840 includes a recovering subunit 841, a traversing subunit 842, and a detection subunit 843.

The recovering subunit 841 is configured to perform the memory recovering operation when it is determined that the estimated remaining memory value is less than the specified value.

Specifically, the recovering subunit 841 is configured to set a memory recovering thread, and perform the memory recovering operation in the memory recovering thread. Further, the recovering subunit 841 is configured to determine whether there is already an existing memory recovering thread in the system, and perform the memory recovering operation in the existing memory recovering thread when it is determined that there is already an existing memory recovering thread in the system, or create a memory recovering thread and perform the memory recovering operation in the created memory recovering thread when it is determined that there is no existing memory recovering thread in the system. The memory recovering thread is a pre-kswapd thread.

Specifically, the recovering subunit 841 is further configured to acquire identifiers of all applications currently running in the background of the electronic device, release a memory space occupied by a specified number of applications currently running in the background corresponding to to-be-processed identifiers, and close the specified number of applications currently running in the background.

Further, regarding the recovering subunit 841 acquiring the identifiers of all applications currently running in the background of the electronic device, the recovering subunit 841 is configured to acquire a current list of inactive file pages in the electronic device, where the list of inactive file pages includes a plurality of inactive file pages, and each of the inactive file pages corresponds to the identifier of one application currently running in the background. Regarding the recovering subunit 841 releasing the memory space occupied by the application currently running in the background corresponding to the to-be-processed identifier, the recovering subunit 841 is configured to write the contents of the inactive file page corresponding to the to-be-processed identifier to the disk, delete the inactive file page is from the list of inactive file pages, and release a memory page corresponding to the inactive file page.

The traversing subunit 842 is configured to acquire the remaining memory value of the electronic device at the end of the memory recovering operation, obtain an updated estimated remaining memory value according to the target memory value and the remaining memory value of the electronic device at the end of the memory recovering operation, and jump to the determining unit to perform the operation of determining whether the estimated remaining memory value is less than the specified value again.

The detection subunit 843 is configured to detect whether there is still an application currently running in the background of the electronic device, acquire the identifiers of all applications currently running in the background of the electronic device when it is determined that there is still an application currently running in the background of the electronic device, and jump to the recovering subunit to perform the operation of releasing the memory space occupied by the specified number of applications currently running in the background corresponding to the to-be-processed identifiers and closing the specified number of applications currently running in the background again.

The detection subunit 843 is further configured to allocate the memory space corresponding to the target memory value to the application when it is determined that there is no application currently running in the background of the electronic device.

Those skilled in the art can clearly understand that, for the convenience and conciseness of the description, the specific working process of the apparatus and units described above can be referred to the corresponding process in the foregoing method embodiments, which will not be repeated here.

Referring to FIG. 9, a structural block diagram of the memory management apparatus 900 provided by the embodiments of the present disclosure is illustrated. The apparatus 900 may include an acquiring unit 910, an obtaining unit 920, a determining unit 930, and a processing unit 940.

The acquiring unit 910 is configured to acquire a memory allocation request sent from an application, where the memory allocation request includes a target memory value required by the application.

The obtaining unit 920 is configured to obtain an estimated remaining memory value according to the target memory value and a remaining memory value of the electronic device.

Specifically, a difference between the remaining memory value and the target memory value is obtained as the estimated remaining memory value.

The determining unit 930 is configured to determine whether the estimated remaining memory value is less than a specified value, where the specified value is greater than a minimum system memory threshold, and the minimum system memory threshold is the minimum memory value required for the system operation of the electronic device.

Specifically, the specified value is the sum of a buffer value and the minimum system memory threshold. The buffer value is set according to a frame buffer. As an implementation, the buffer value is a multiple of a preset memory value, where the preset memory value is the size of a memory space occupied by the frame buffer. For example, the buffer value is triple of the preset memory value.

The processing unit 940 is configured to perform a memory recovering operation and then allocate a memory space corresponding to the target memory value to the application, when it is determined that the estimated remaining memory value is less than the specified value.

Specifically, the processing unit 940 includes a recovering subunit 941 and an allocation subunit 942.

The recovering subunit 941 is configured to perform the memory recovering operation when it is determined that the estimated remaining memory value is less than the specified value.

The allocation subunit 942 is configured to allocate the memory space corresponding to the target memory value to the application upon ending of the memory recovering operation.

Further, the recovering subunit 941 is further configured to acquire identifiers of all applications currently running in the background of the electronic device. The allocation subunit 942 is further configured to release the memory space occupied by all the applications currently running in the background corresponding to the acquired identifiers, and close all the applications currently running in the background.

Those skilled in the art can clearly understand that, for the convenience and conciseness of the description, the specific working process of the apparatus and units described above can be referred to the corresponding process in the foregoing method embodiments, which will not be repeated here.

In the several embodiments provided in this disclosure, the coupling between the units may be electrical, mechanical or in other forms.

In addition, the functional units in the various embodiments of the present disclosure may be integrated into one processing unit, or the individual units may exist alone physically, or two or more units may be integrated into one unit. The above-mentioned integrated units can be implemented in the form of hardware or software function modules.

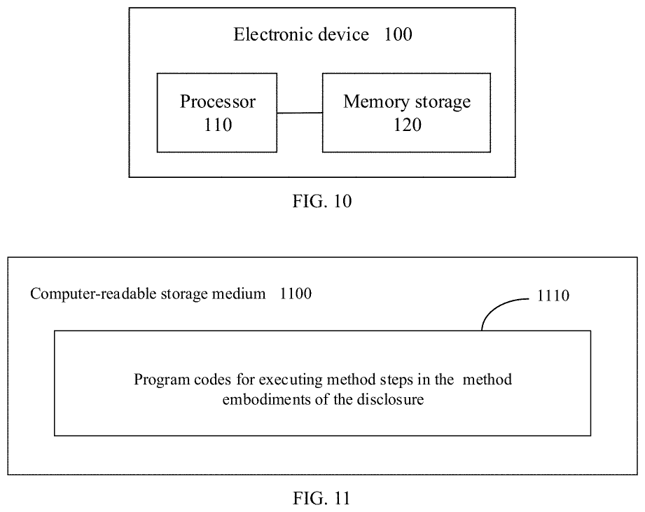

Referring to FIG. 10, a structural block diagram of an electronic device provided by the embodiments of the present disclosure is illustrated. The electronic device 100 may be an electronic device capable of running applications, such as a smart phone, a tablet computer, or an e-book. The electronic device 100 in the embodiments of this disclosure may include one or more of the following components: a processor 110, a memory storage 120, and one or more programs, where the one or more programs may be stored in the memory storage 120 and configured to be executed by one or more processors 110 to implement the methods described in the foregoing method embodiments.

The processor 110 may include one or more processing cores. The processor 110 uses various interfaces and lines to connect various parts of the entire electronic device 100, and executes various functions and processes data of the electronic device 100 by running or executing instructions, programs, code sets, or instruction sets stored in the memory storage 120, and calling data stored in the memory storage 120. Optionally, the processor 110 may be implemented in at least one hardware of Digital Signal Processing (DSP), Field-Programmable Gate Array (FPGA), and Programmable Logic Array (PLA). The processor 110 may be integrated with one of a Central Processing Unit (CPU), a Graphics Processing Unit (GPU), a modem, or a combination thereof. The CPU mainly processes the operating system, user interfaces and applications, etc. The GPU is responsible for rendering and drawing of display contents. The modem is used for processing wireless communication. It can be understood that the modem may not be integrated into the processor 110, but may be implemented by a separate communication chip.

The memory storage 120 may include Random Access Memory (RAM) or Read-Only Memory (ROM). The memory storage 120 may be used to store instructions, programs, codes, code sets or instruction sets. The memory storage 120 may include a program storage area and a data storage area. The program storage area may store instructions for implementing the operating system, instructions for implementing at least one function (such as touch function, sound playback function, and image playback function), and instructions for implementing the above various method embodiments, etc. The storage data area can also store data (such as phone book, audio and video data, chat record data) created by the electronic device 100 during use.

Referring to FIG. 11, a structural block diagram of a computer-readable storage medium provided by the embodiments of the present disclosure is illustrated. The computer-readable medium 1100 stores program codes therein, and the program codes can be invoked by the processor to execute the method described in the foregoing method embodiments.

The computer-readable storage medium 1100 may be an electronic memory such as flash memory, Electrically Erasable Programmable Read Only Memory (EEPROM), EPROM, hard disk, or ROM. Optionally, the computer-readable storage medium 1100 includes a non-transitory computer-readable storage medium. The computer-readable storage medium 1100 has a storage space for the program codes 1110 for executing any method steps in the above-mentioned methods. These program codes can be read from or written into one or more computer program products. The program codes 1110 may be for example compressed in an appropriate form.

Finally, it should be noted that the above embodiments are only used to illustrate the technical solutions of the disclosure, rather than limiting the disclosure. Although the disclosure has been described in detail with reference to the foregoing embodiments, those of ordinary skill in the art should understand that modification can still be made to the technical solutions recorded in the foregoing embodiments, or equivalent replacement can be made to some of the technical features thereof, and these modifications or replacements do not drive the essence of the corresponding technical solutions to depart from the spirit and scope of the technical solutions of the embodiments of the present disclosure.

What is claimed is:

1. A memory management method, performed by an electronic device, the method comprising:
acquiring a memory allocation request sent from an application installed in the electronic device, wherein the memory allocation request comprises a target memory value required by the application;
obtaining an estimated remaining memory value according to the target memory value and a remaining memory value of the electronic device;
determining whether the estimated remaining memory value is less than a specified value, wherein the specified value is greater than a minimum system memory threshold, and the minimum system memory threshold is a minimum memory value required for system operation of the electronic device; and
in response to determining that the estimated remaining memory value is less than the specified value, performing a memory recovering operation and allocating a memory space corresponding to the target memory value to the application sending the memory allocation request.

2. The method as claimed in claim 1, wherein the specified value is a sum of a buffer value and the minimum system memory threshold, and the buffer value is set according to a frame buffer.

3. The method as claimed in claim 2, wherein the buffer value is a multiple of a preset memory value, and the preset memory value is a size of a memory space occupied by the frame buffer.

4. The method as claimed in claim 3, wherein the buffer value is triple of the preset memory value.

5. The method as claimed in claim 1, further comprising:
after the memory recovering operation is performed,
acquiring a remaining memory value of the electronic device at an end of the memory recovering operation, as an updated remaining memory value of the electronic device, and obtaining an updated estimated remaining memory value according to the target memory value and the updated remaining memory value of the electronic device; and
returning to the operation of determining whether the estimated remaining memory value is less than the specified value.

6. The method as claimed in claim 5, wherein the performing the memory recovering operation comprises:
acquiring identifiers of all applications currently running in a background of the electronic device;
selecting, as at least one to-be-processed identifier, a specified number of identifiers from the acquired identifiers of all the applications currently running in the background; and
releasing a memory space occupied by a specified number of applications currently running in the background corresponding to the at least one to-be-processed identifier, and closing the specified number of applications currently running in the background.

7. The method as claimed in claim 6, wherein the selecting, as at least one to-be-processed identifier, a specified number of identifiers from the acquired identifiers of all the applications currently running in the background, comprises:
selecting, as candidate identifiers, identifiers of non-system applications currently running in the background from the acquired identifiers of all the applications currently running in the background; and
selecting, as the at least one to-be-processed identifier, a specified number of identifiers from the candidate identifiers.

8. The method as claimed in claim 7, wherein the selecting, as the at least one to-be-processed identifier, a specified number of identifiers from the candidate identifiers comprises:
selecting identifiers corresponding to a preset application type from the candidate identifiers; and
selecting, as the at least one to-be-processed identifier, a specified number of identifiers from the identifiers corresponding to the preset application type.

9. The method as claimed in claim 8, wherein the selecting, as the at least one to-be-processed identifier, a specified number of identifiers from the identifiers corresponding to the preset application type comprises:
determining a usage frequency corresponding to each of the identifiers corresponding to the preset application type;
arranging the identifiers corresponding to the preset application type in an ascending order according to the determined usage frequencies, to obtain a first usage sequence; and
selecting, as the at least one to-be-processed identifier, first N identifiers from the first usage sequence, where N is a positive integer.

10. The method as claimed in claim 8, wherein the selecting, as the at least one to-be-processed identifier, a specified number of identifiers from the identifiers corresponding to the preset application type comprises:
determining a most recent usage time corresponding to each of the identifiers corresponding to the preset application type;
arranging the identifiers corresponding to the preset application type in an order from early to late according to the determined most recent usage time, to obtain a second usage sequence; and
selecting, as the at least one to-be-processed identifier, first N identifiers from the second usage sequence, where N is a positive integer.

11. The method as claimed in claim 8, wherein the selecting, as the at least one to-be-processed identifier, a specified number of identifiers from the identifiers corresponding to the preset application type comprises:
determining a usage frequency corresponding to each of the identifiers corresponding to the preset application type;
arranging the identifiers corresponding to the preset application type in an ascending order according to the determined usage frequencies, to obtain a first usage sequence;
selecting top M identifiers from the first usage sequence, and determining a most recent usage time corresponding to each of the M identifiers, where M is a positive integer;
arranging the M identifiers in an order from early to late according to the determined most recent usage time, to obtain a third usage sequence; and
selecting, as the at least one to-be-processed identifier, first N identifiers from the third usage sequence, where N is a positive integer and M is greater than N.

12. The method as claimed in claim 6, wherein after returning to the operation of determining whether the estimated remaining memory value is less than the specified value, the method further comprises:
in response to determining that the updated estimated remaining memory value is less than the specified value, detecting whether there is still an application currently running in the background of the electronic device;
in response to detecting that there is still an application currently running in the background of the electronic device, performing the memory recovering operation again, until the estimated remaining memory value is greater than or equal to the specified value or until there is no application currently running in the background of the electronic device; and
in response to detecting that there is no application currently running in the background of the electronic device, allocating the memory space corresponding to the target memory value to the application sending the memory allocation request.

13. The method as claimed in claim 1, wherein the performing a memory recovering operation and allocating a memory space corresponding to the target memory value to the application sending the memory allocation request, comprises:
performing the memory recovering operation; and
allocating the memory space corresponding to the target memory value to the application directly upon ending of the memory recovering operation.

14. The method as claimed in claim 13, wherein the performing the memory recovering operation comprises:
acquiring identifiers of all non-system applications currently running in a background of the electronic device, as candidate identifiers;
selecting, as to-be-processed identifiers, all identifiers corresponding to a preset application type from the candidate identifiers; and
releasing a memory space occupied by all the applications currently running in the background corresponding to the to-be-processed identifiers, and closing all the applications currently running in the background corresponding to the to-be-processed identifiers.

15. The method as claimed in claim 6, wherein the acquiring identifiers of all applications currently running in the background of the electronic device comprises:
acquiring a current list of inactive file pages in the electronic device, wherein the list of inactive file pages comprises a plurality of inactive file pages, and each of the inactive file pages corresponds to the identifier of one of the applications currently running in the background; and
wherein the releasing the memory space occupied by the application currently running in the background corresponding to each to-be-processed identifier, comprises:
writing contents of the inactive file page corresponding to the to-be-processed identifier to a disk, and deleting the inactive file page from the list of inactive file pages; and
releasing a memory page corresponding to the inactive file page.

16. The method as claimed in claim 1, wherein the performing the memory recovering operation comprises:
determining whether there is an existing memory recovering thread in a system of the electronic device;
in response to determining that there is an existing memory recovering thread in the system, performing the memory recovering operation in the existing memory recovering thread; and
in response to determining that there is no existing memory recovering thread in the system, creating a memory recovering thread, and performing the memory recovering operation in the created memory recovering thread.

17. The method as claimed in claim 16, wherein the memory recovering thread is a pre-kswapd thread.

18. The method as claimed in claim 1, wherein the obtaining an estimated remaining memory value according to the target memory value and a remaining memory value of the electronic device, comprises:
obtaining a difference between the remaining memory value and the target memory value, as the estimated remaining memory value.

19. An electronic device, comprising:
one or more processors;
a memory storage; and
one or more programs, wherein the one or more programs are stored in the memory storage, and configured to be executed by the one or more processors to implement a memory management method comprising:
upon receiving a memory allocation request from an application installed in the electronic device, obtaining an estimated remaining memory value of the electronic device, wherein the memory allocation request comprises a target memory value required by the application;
in response to determining that the estimated remaining memory value is less than a specified value, performing a memory recovering operation and allocating a memory space corresponding to the target memory value to the application, wherein the specified value is greater than a minimum system memory threshold, and the minimum system memory threshold is a minimum memory value required for system operation of the electronic device; and
in response to determining that the estimated remaining memory value is greater than or equal to the specified value, directly allocating the memory space corresponding to the target memory value to the application.

20. A non-transitory computer-readable medium, storing program codes executable by a processor, wherein when a plurality of instructions in the program codes are executed by the processor, the processor is caused to implement a memory management method comprising:
receiving a memory allocation request from an application installed in an electronic device, wherein the memory allocation request comprises a target memory value required by the application;
obtaining an estimated remaining memory value of the electronic device in response to the memory allocation request; and
in response to determining that the estimated remaining memory value is less than a specified value, performing a memory recovering operation and allocating a memory space corresponding to the target memory value to the application, wherein the specified value is greater than a minimum system memory threshold, and the minimum system memory threshold is a minimum memory value required for system operation of the electronic device.
